(19) United States
(12) Patent Application Publication
(10) Pub. No.: US 2013/0022167 A1
(43) Pub. Date: Jan. 24, 2013

(54) High Speed, Non-Destructive, Reel-to-Reel Chip/Device Inspection System and Method Utilizing Low Power X-rays/X-ray Fluorescence

(71) Applicants: Guilherme Cardoso, Carlsbad, CA (US); Marcos Turqueti, Vista, CA (US); Griffin Lemaster, Murrieta, CA (US); Shawn Linden, Oceanside, CA (US); Justin White, San Diego, CA (US)

(72) Inventors: Guilherme Cardoso, Carlsbad, CA (US); Marcos Turqueti, Vista, CA (US); Griffin Lemaster, Murrieta, CA (US); Shawn Linden, Oceanside, CA (US); Justin White, San Diego, CA (US)

(73) Assignee: CREATIVE ELECTRON, INC., San Marcos, CA (US)

(21) Appl. No.: 13/556,169

(22) Filed: Jul. 23, 2012

Related U.S. Application Data
(60) Provisional application No. 61/510,982, filed on Jul. 22, 2011.

(51) Int. Cl. G01B 15/00; G01N 23/201; G01N 23/223

(52) U.S. Cl. 378/46; 378/58; 378/86

(57) ABSTRACT

A reel-like format for transporting devices under test (DUT) into low power x-ray inspection system allows for high speed transportation and inspection that is several orders of magnitude faster than conventional systems. The system can be configured with a conveyor belt for handling of non-reel suitable DUTs. A stabilizing control mechanism precisely and accurately brings the tape (with components) into the x-raying window, that allows spatial displacement of a portion of the to-be-viewed tape.

### CROSS-REFERENCE TO RELATED APPLICATION(S)

This application claims the benefit of U.S. Provisional Patent Application No. 61/510,982, filed Jul. 22, 2011, the contents of which are hereby incorporated by reference in its entirety.

### FIELD

The present disclosure is in the field of automated inspection systems utilizing non-destructive low power x-rays.

### BACKGROUND

Automated X-ray inspection (AXI) is a technology that utilizes x-rays as a source of energy to penetrate objects and reveal features that are not visible or hidden from view. With the increasing use of integrated circuits with components/connections that are not visible or bonded beneath the chip, normal optical inspection methods for quality control are not possible. Additionally, with the high volume of chips that are transported across borders, there has been an increasing concern regarding the ability to easily and rapidly detect counterfeit chips/devices. While the inspection of electronic or other devices with x-rays are known, these systems are very manual-labor intensive and are very slow, thus causing the inspection process to be fraught with human error.

Accordingly, there has been a long standing need in the x-ray inspection community for methods and systems that allow for high speed, non-destructive, and accurate inspection of individual chips and/or objects under inspection.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect o the disclosure, an automatic, high speed, device-under-test inspection system utilizing low power x-rays and/or XRF system is provided, comprising: an x-ray power source; at least one of a reeling (reel) mechanism or conveyor mechanism for supporting electrical components to be inspected; a controlling and feeding mechanism for controlling reeling/conveyer speed and location/timing of components within the reel/conveyor for placement within/under/proximal to the x-ray power source; an x-ray detector; and a computer, processing information from the x-ray detector capable of comparing the processed information to an exemplar, for detection of faults or discrepancies in the electrical component examined.

In another aspect of the disclosure, the above inspection system is provided, wherein an automatic wherein x-ray fluorescence is utilized in addition to the x-ray to determine at least one chemical property of the electrical component examined; and/or wherein the controlling and feeding mechanism is a plurality of mechanisms; and/or wherein the controlling and feeding mechanism moves in at least one of an x-y-z axis, a tape from the reel into or out of a viewing range of the x-ray power source; and/or wherein the electronic components are encapsulated in the tape and are at least one of a computer chip, memory chip, and semiconductor device.

In another aspect of the disclosure, a method for automatic, high speed, device-under-test inspection, utilizing low power x-rays and/or XRF system is provided, comprising: feeding an electrical component via a reeling/conveyor belt mechanism into a viewing window of an x-ray source; controlling the location/timing of components within the reel/conveyor for placement within/under/proximal to the x-ray power source exposing the electrical component to low power x-rays from the x-ray source; detecting pass-through or scattering of the x-rays via an x-ray detector; processing information from the x-ray detector capable to compare the processed information to an exemplar, for detection of faults or discrepancies in the electrical component examined; and/or wherein x-ray fluorescence is utilized in addition to the x-ray to determine at least one chemical property of the electrical component examined; and/or moving in at least one of an x-y-z axis, a tape (or the electronic component on the conveyor) from the reel into or out of a viewing range of the x-ray power source.

In yet another aspect of the disclosure, a system for automatic, high speed, device-under-test inspection, utilizing low power x-rays and/or XRF system is provided, comprising: means for feeding an electrical component via a reeling/conveyor belt mechanism into a viewing window of an x-ray source; means for controlling the location/timing of components within the reel/conveyor for placement within/under/proximal to the x-ray power source; means for exposing the electrical component to low power x-rays from the x-ray source; means for detecting pass-through or scattering of the x-rays via an x-ray detector; means for processing information from the x-ray detector capable to compare the processed information to an exemplar, for detection of faults or discrepancies in the electrical component examined.

### BRIEF DESCRIPTION OF THE DRAWING

FIG. 1 is a partial cut-away illustration of an exemplary x-ray inspection system.

FIG. 2A is a close-up illustration of a reel side assembly.

FIG. 2B is an illustration of one example of a tape with DUTs.

FIG. 3A is an illustration of an exemplary 2-axis table.

FIG. 3B is an illustration of an adjustable height reel system.

FIG. 4. is an illustration of an exemplary inspection system using a conveyor belt.

### DETAILED DESCRIPTION

In various exemplary embodiments, an automatic device/object inspection system(s) and method(s) is disclosed that utilizes a reel-like format for transporting devices under test (DUT) into x-ray inspection system. Some attributes of the exemplary embodiments allow for actual inspection of each individual DUT on the reel and a comparison of the x-ray image of the DUT to an x-ray image of an exemplar component(s). Since no physical contact with the DUT is necessary, delicate DUT circuits are not exposed to contact-induced electrostatic charges. Due to a “tape” based transport system, automated high speed transportation and inspection can now be achieved, being nearly several orders of magnitude faster than conventional systems. What may have taken days to process with prior art systems, the exemplary embodiments can now process in mere hours or less. In one exemplary embodiment, in excess of 1,000 DUTs can be inspected in less than 5 minutes.

Additional attributes in some embodiments include integrated software to rapidly and accurately detect anomalies in the DUT. Other attributes include multiple viewing screens that allow different perspectives/types of images/statistics, etc., for easy operator control and inspection, including High Definition, depending on configuration. Magnifications of in excess of 2000× can be achieved in some embodiments. Additional attributes include high resolution inspection (for example, 5 μm or smaller) without damaging or compromising the integrity of the DUTs.

Additional attributes include the use of a reel-type transport system. In some embodiments, the exemplary system can be configured with a conveyor belt-like system for handling of non-reel suitable DUTs.

Optical zoom, precise movement of the reeling mechanisms in one or more axes (x-y-z), and alignment can be obtained using an optical encoder that reads holes in the tape or light patterns from the tape (including, in some embodiments, light patterns from the actual components “on” the tape). In some embodiments, an automatic marking/sealing of the “passed” products is facilitated, such as automatic sealing/bagging on a rewound reel. Different size reels and types of components can be examined. In other embodiments, an electronic static discharge (ESD) mitigation device can be implement on the tape to reduce or tap any build up of electricity on the inspected components and/or tape itself.

In other embodiments, a stabilizing control mechanism is devised to precisely and accurately bring the tape (with components) into the x-raying window, that allows spatial displacement of a portion of the to-be-viewed tape.

In other embodiments, a combination of x-rays and x-ray fluorescence is used for inspection. This allows for “chemical” analysis of the samples, using a procedure similar to spectroscopy. By combing these two mechanisms, increased analysis capabilities and throughput is now realizable. Cost saving are evident by using a single system capable of using two “different” detection schemes, and the same or similar x-ray source.

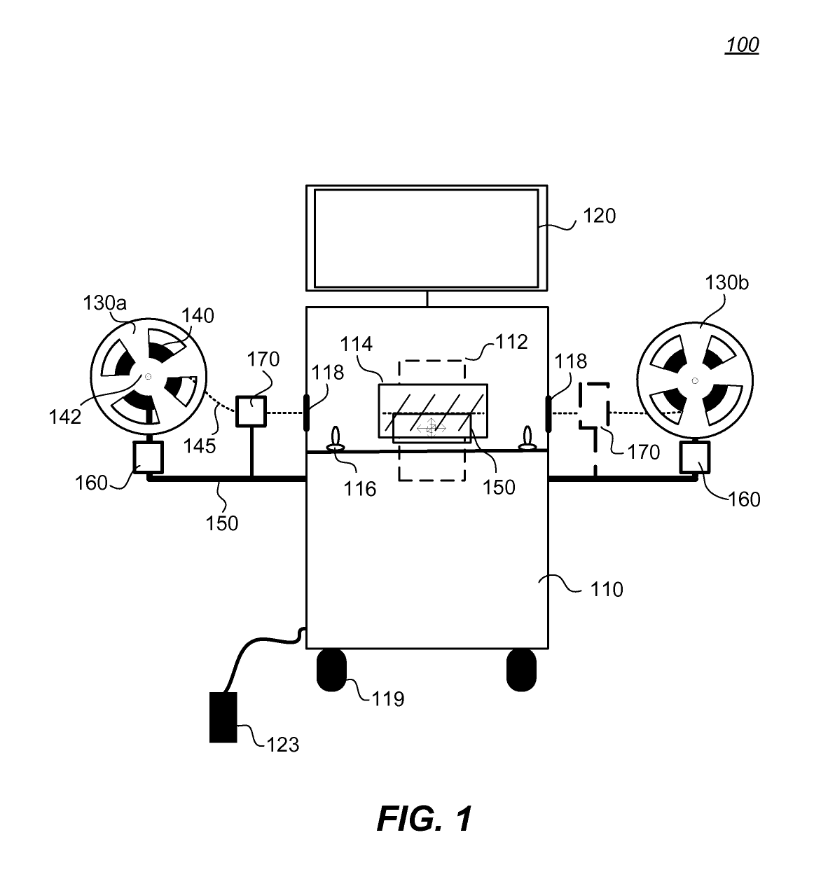

FIG. 1 is a partial cut-away illustration of an exemplary x-ray inspection system 100. The inspection system 100 comprises a cabinet 110 (with entrance/exit portals 118, and optional casters/wheels 119 and activation foot pedal 123) that houses an x-ray source/machine with attendant detector 112, a shielded viewing window 114, computer (not shown), input/output/controller/joysticks 116, and display 120. The x-ray source/machine with attendant detector 112 can be configured as a simple x-ray source, for example, it can have a “tube” voltage of 20-80 kV microfocus variable, or 20-120 kV (microfocus variable), 20-50 kV variable, etc.; a tube current of 0-1 mA, x-ray camera with 4×-18× zoom.

An optical camera can also be placed in proximity of the x-ray source/machine/detector 112, so as to provide a video feed (aka—record) of the images. The optical camera can have a 2M+HD sensor, with resolution of <5 μm. A field of view of 1″×2″, 2″×2″, 4″×4″ can be implemented. Frame averaging of 0-128 with image freeze can be implemented.

The x-ray source/machine/detector 112 can be configured to operate as an X-ray fluorescence (XRF) detector, by using the appropriate detector(s). In some embodiments, a combination of x-rays and x-ray fluorescence can be used for inspection. This technique allows for spectroscopy-like analysis. By combing these two approaches, increased analysis capabilities and throughput can be achieved.

The cabinet 110 operates to support/house various inspection equipment, but most importantly operates to shield the user from x-rays from the x-ray source 112. Entrance/exit portals 118 are openings in the side of the cabinet 110, but are “shielded” openings, having perhaps a flexible curtain/ribbons of x-ray absorbing material, which allow tape 145 containing DUTs to enter and exit the cabinet 110. In some embodiments, the curtain/ribbons can be leaded strips of fabric, for example. The computer may be inside the cabinet 110 or external to the cabinet 110, depending on implementation preferences. The display 120 may be a single display, or multiple displays (i.e., screens). In some embodiments, the display 120 may be situated where the viewing window 114, acting as a virtual proxy to the viewing window. For example, a pad-computer or tablet-computer may be used instead of the viewing window 114.

Input/output/controller/joysticks 116 can be any one or more of a combination of physical devices used to control operation of the exemplary inspection system 100. For example, in some embodiments, a keyboard may be used instead or with the joysticks, to assist in controlling the exemplary inspection system 100. Similarly, a computer mouse/pointing device may be used, as well as other human-interface devices and so forth. The keyboard, if so implemented, may be removable or be based on a shelf that is removable, for ease of system relocation. The computer may be contained in the base of the cabinet 110, as well as attendant cabling. The viewing window 114 may be implemented as part of a access “door” that is openable by the user, to allow the user to actually inspect by “hand” the DUT within the viewing window 114, or for placement of items for inspection. The door can be held open by gas tubes or springs to allow two-hand loading and placement. The door would be x-ray shielded to provide protection to the user.

Multiple manipulation “table” 150 is shown supporting the viewable portion of tape 145 in the viewing window 114. Table 150 is movable in several axes of direction. In one embodiment, the table 150 moves in 3-axes of direction, allowing the viewed (inspected) portion of tape 145 to be moved in all six degrees. This allows for a tape-side focusing or positioning of the DUTs on tape 145, as well as for any other spatially related adjustment, if needed.

The exemplary inspection system 100 further comprises support arms 150 that hold encoder(s) 170 (FIG. 1 shows two encoders, but in some embodiments, only one encoder may be needed), reel motor(s) 160, reels 130a,b and spooled tape 140 which contains DUTs that are spaced at nearly regular intervals along the tape 145. Encoder 170 operates to “measure” the rate of travel and/or positioning of the tape 145 and its respective DUTs. Encoder 170 can utilize an optical system for “registering” the position of the the respective DUT within the tape, or any other system that provides for object position and/or velocity measurement.

The reel motor(s) 160 may spin the reels 130a,b via a friction wheel (not shown) resting against a portion of the reel or via a cable/chain (not shown) attached directly or indirectly to the reel supporting axis 142. The reel motor(s) 160 are controlled by the computer via actions from the input/output/controller/joysticks 116. Various methods and mechanics for controllably spinning a reel to load or unload the reel are known in the art and therefore the details thereof are omitted, understanding that they are within the purview of one ordinary skill in the art.

In operation, presuming the left side of FIG. as the “starting” side, a user would load a reel 130a of DUTs onto the axis 142 and feed the leader of tape 145 into the encoder 170, into cabinet 110 via entrance portal 118 and through source/detector 112 and exit the cabinet via exit portal 118. The leader (of tape 145) would be fed into pickup reel 130b (presuming there is not an encoder 170 at the exit side of the cabinet). Exit side motor 160 (right of FIG. 1) would operate to spin pickup reel 130b, with a predetermined amount of tension on tape 145 to cause loaded reel 130a to spin in tandem.

The exemplary system's computer would contain specialized software for controlling x-ray source/detector 112 as well as imaging software capable of comparing with a great deal of sophistication, images from the x-ray source/detector 112 with baseline images for non-counterfeit or acceptable DUTs. Such specialized software can “flag” out-of-bounds DUTs and mark/alert them to the user. The inventors utilized software called the SMART ™ suite provided by Creative Electron, Inc., San Marcos, Calif. The software may have an option to “cool” down the x-ray source and turn off the camera(s), if desired, to prolong the longevity of both the source and the camera(s). Therefore, an intermittent operation mode can be utilized, that is automatic (continue automatic inspection, flag a out-of-bounds DUT—if found, power down source when source is over heating, stop inspection, when cool return to automatic inspection). The cool-down periods can be user selected, if so desired. Joystick 116 can be used to control the direction of travel or used to “manually” move a desired DUT under the x-ray source/detector 112. Pedal 123 can be used for activation as well as a key (not shown), if so desired. While FIG. 1 illustrates a left-to-right scenario, it is understood that a right-to-left scenario can be easily accommodated implemented.

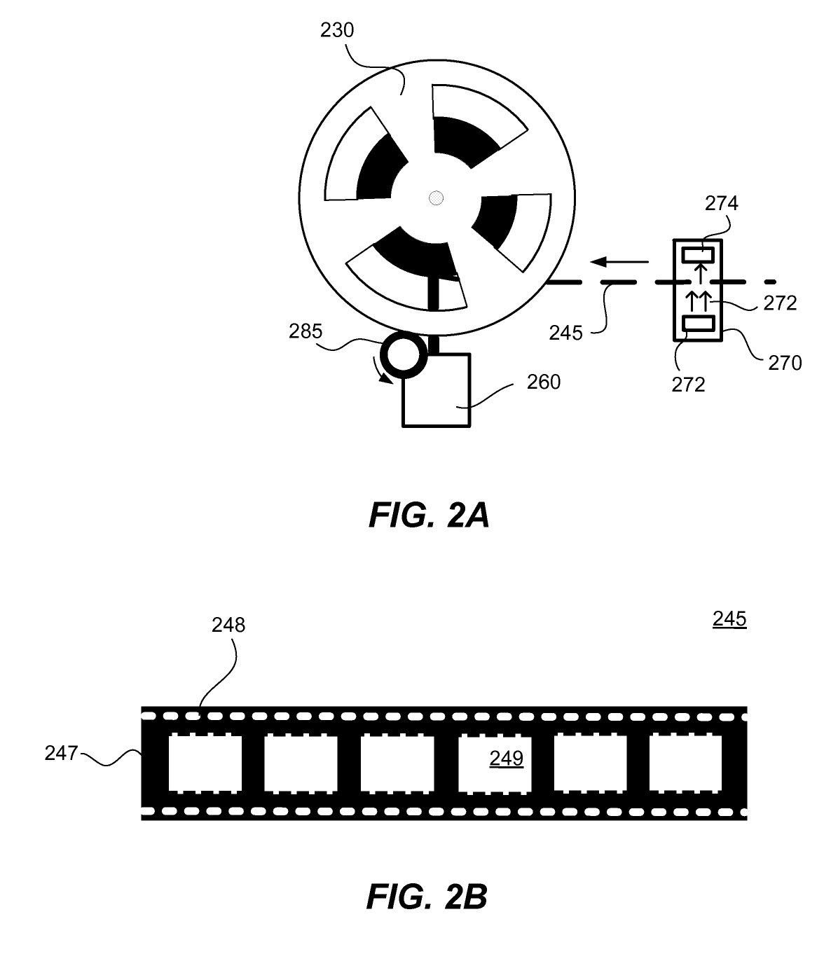

FIG. 2A is a close-up illustration of a reel side assembly, showing reel 230 being “spun” by friction wheel 285 driven by motor 260. The motor 260 is controllable in discrete steps, allowing for movement of the reel 260, causing tape 245 to travel in precise increments through encoder 270 which sends an optical signal (aka light) 272 to encoder detector 274. Optical encoder technology is well known in the art and therefore further elaboration is not provided.

FIG. 2B is an illustration of one example of a tape 245 with DUTs 249 disposed along the tape 245 and optional sprocket holes 248 disposed along the edges of tape 245. The sprocket holes 245, while typically used for alignment and tracking of the tape 245, can also used as registration points with the optical encoder 270 of FIG. 1A. Alternatively, or in tandem, the “dark” portions 247 between the DUTs can be used as registration points. By noting the demarcation between the “light” portions and the “dark” portions, a form of positioning and measurement of the distance traveled can be obtained, especially if the sprocket hole 238 distances (and/or DUT separation distances) are known to be a fixed value.

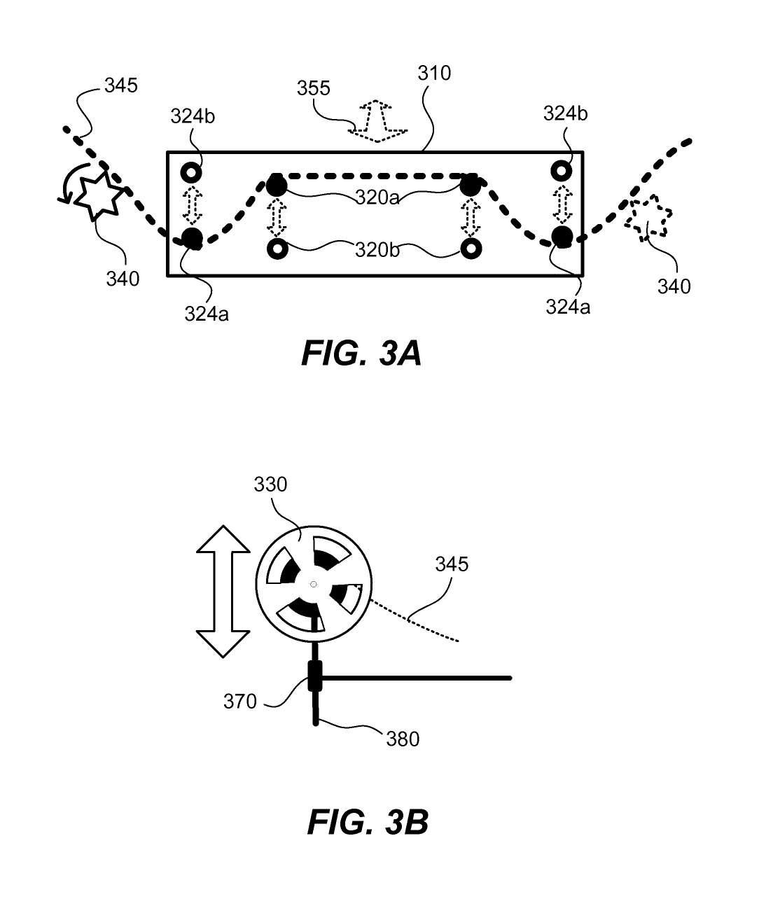

FIG. 3A is an illustration of an exemplary 2-axis table 310 that is adjustable in the y-axis (back/forward) and z-axis (up/down). Tape 345 guided/driven by sprocket 340 carries tape 345 across pairs of adjustable “height” outer wheels 324 (a,b), where 324a represents the lower position and 324b represents the upper position. Inner wheels 320 (a,b) where 320a represents the upper position and 320b represents the lower position. Wheels 320 (a,b) are also adjustable in “height” and in combination with wheels 324 (a,b) provide tension on tape 245 to ensure it is stable as it passes through the source/detector (not shown). Arrow 355 indicates that the table 310 can be moved in the y-axis (back/forward).

It is understood that while FIG. 3A shows a 2-axis operation, it is understood that 3-axis operation can easily be achieved by having the table 310 move laterally (left/right). However, since the tape 345 travels left/right, it is not necessary to have the table 310 replicate this movement. However, in some embodiments, it may be desirable to have table 310 move left/right, to form a 3-axis motion table.

FIG. 3B is an illustration of an adjustable height reel system for use with an exemplary inspection system. Reel 330 contains tape 345 mounted to a spindle that is adjustable in height via support 380 that can be raised/lowered by releasing clamp 370. This allows for reels of different sizes to be fitted and also for tailoring the height of the reel 330 so that tape 345 can be properly positioned for entry into the inspection system.

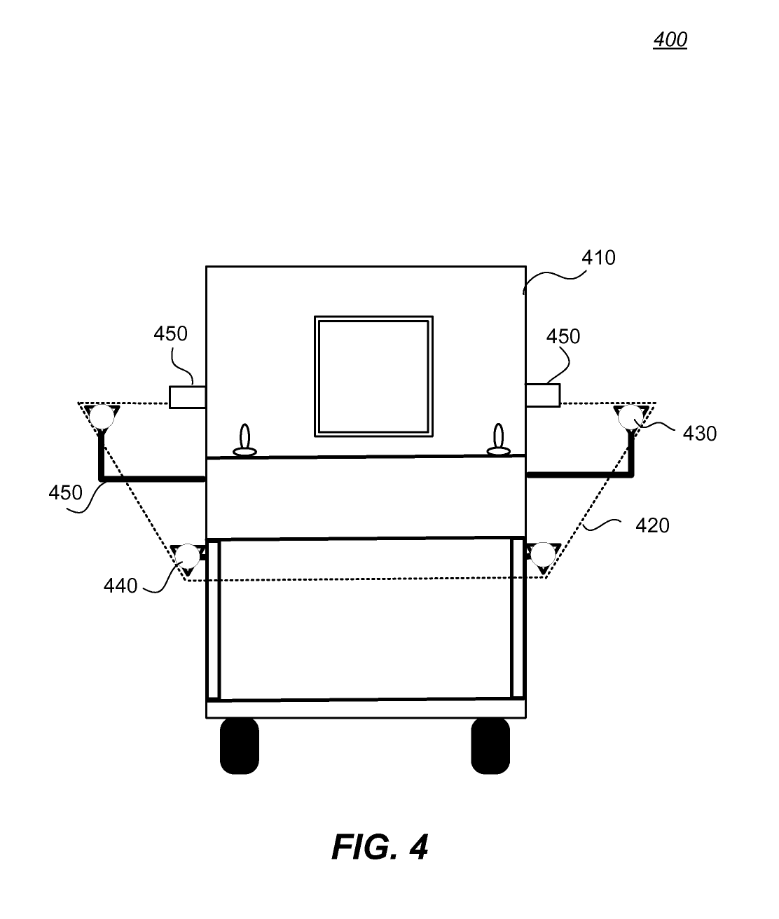

FIG. 4. is an illustration of an exemplary inspection system 400 using a conveyor belt 420 to bring DUTs into the cabinet 410, via extended portals 450. The conveyor belt may be one or more “chains” analogous to a bicycle chain, but made of a non-metallic material so as to be transparent to x-rays. “Wheels” 430, 440 drive the conveyor belt 420, whereas wheels 430 are at a height substantially level to the extended portals 450, while wheels 440 are below the extended portals. Only one set or one wheel of the wheels 430, 440 may be powered. The portals 450 are large enough for a typical DUT but small enough to prevent entry of a normal sized human hand. For safety purposes, a “trap door” may be used to seal the ends of portals 450, wherein the trap door may be configured with a sensor/trigger that turns off the x-ray source when the door is open and allows the x-ray source to turn on when the door is closed. The exemplary inspection system 400, while purposed in this FIG. for conveyor belt operation can easily be converted to reel-to-reel operation by removing the appropriate wheels and attaching the lacking hardware to supports 450.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. An automatic, high speed, device-under-test inspection system utilizing low power x-rays and/or XRF system, comprising:
an x-ray power source;
at least one of a reeling (reel) mechanism or conveyor mechanism for supporting electrical components to be inspected;
a controlling and feeding mechanism for controlling reeling/conveyer speed and location/timing of components within the reel/conveyor for placement within/under/proximal to the x-ray power source;
an x-ray detector; and
a computer, processing information from the x-ray detector capable of comparing the processed information to an exemplar, for detection of faults or discrepancies in the electrical component examined.

2. The system of claim 1, wherein x-ray fluorescence is utilized in addition to the x-ray to determine at least one chemical property of the electrical component examined.

3. The system of claim 1, wherein the controlling and feeding mechanism is a plurality of mechanisms.

4. The system of claim 1, wherein the controlling and feeding mechanism moves in at least one of an x-y-z axis, a tape from the reel into or out of a viewing range of the x-ray power source.

5. The system of claim 1, wherein the electronic components are encapsulated in the tape and are at least one of a computer chip, memory chip, and semiconductor device.

6. A method for automatic, high speed, device-under-test inspection, utilizing low power x-rays and/or XRF system, comprising:
feeding an electrical component via a reeling/conveyor belt mechanism into a viewing window of an x-ray source;
controlling the location/timing of components within the reel/conveyor for placement within/under/proximal to the x-ray power source;
exposing the electrical component to low power x-rays from the x-ray source;
detecting pass-through or scattering of the x-rays via an x-ray detector;
processing information from the x-ray detector capable to compare the processed information to an exemplar, for detection of faults or discrepancies in the electrical component examined.

7. The method of claim 6, wherein x-ray fluorescence is utilized in addition to the x-ray to determine at least one chemical property of the electrical component examined.

8. The method of claim 6, further comprising moving in at least one of an x-y-z axis, a tape (or the electronic component on the conveyor) from the reel into or out of a viewing range of the x-ray power source.

9. A system for automatic, high speed, device-under-test inspection, utilizing low power x-rays and/or XRF system, comprising:
means for feeding an electrical component via a reeling/conveyor belt mechanism into a viewing window of an x-ray source;
means for controlling the location/timing of components within the reel/conveyor for placement within/under/proximal to the x-ray power source;
means for exposing the electrical component to low power x-rays from the x-ray source;
means for detecting pass-through or scattering of the x-rays via an x-ray detector;
means for processing information from the x-ray detector capable to compare the processed information to an exemplar, for detection of faults or discrepancies in the electrical component examined.
